(19) United States
(12) Patent Application Publication
(10) Pub. No.: US 2026/0184843 A1
(43) Pub. Date: Jul. 2, 2026

(54) BIO-BASED BENZOXAZINES CONTAINING DYNAMIC ESTER BOND AND COMPOSITES THEREOF

(71) Applicants: CASE WESTERN RESERVE UNIVERSITY, Cleveland, OH (US); Material Answers LLC, Weston, MA (US)

(72) Inventors: Christopher E. Scott, Weston, MA (US); Hatsuo Ishida, Cleveland, OH (US); Scott Allen Winroth, Groton, MA (US)

(21) Appl. No.: 19/434,065

(22) Filed: Dec. 29, 2025

Related U.S. Application Data
(60) Provisional application No. 63/739,220, filed on Dec. 27, 2024.

(51) Int. Cl. C08G 59/62; C08G 73/06; C08J 5/04

(52) U.S. Cl. CPC C08G 59/623; C08G 73/0688; C08J 5/04; C08J 2379/04

(57) ABSTRACT

A polybenzoxazine includes a cured benzoxazine resin, wherein the benzoxazine resin has a structure of formula (I), (II), or (III) and the polybenzoxazine has at least one of a char yield at 800° C. under an inert atmosphere of about 34% or higher, a limiting oxygen index of about 31 or higher, or a glass transition temperature of about 100° C. or higher.

### RELATED APPLICATION

This application claims priority from U.S. Provisional Application No. 63/739,220, filed Dec. 27, 2024, the subject matter of which is incorporated herein by reference in its entirety.

### GOVERNMENT FUNDING

This invention was made with support under grant DE-SC0022869 awarded by the United States Department of Energy. The Government has certain rights in the invention.

### FIELD OF THE INVENTION

The present invention is in the technical field of polymer compositions. More particularly, the present invention relates to benzoxazine compositions, composites therefrom, and their preparation.

### BACKGROUND

Polybenzoxazines are a class of thermosetting polymers that belong to the family of addition-curable phenolic resins. One type of benzoxazine includes monomers synthesized from different phenols and amines of varying backbone structures. Polybenzoxazines have gained interest because of their unique thermal and mechanical properties and their flexible synthesis chemistry that allows for compounds tailored to specific applications. The unique properties of polybenzoxazines originate from their hydrogen-bonded structures. Polymerization of benzoxazines can be achieved through the cationic ring opening of the oxazine ring, with or without an added initiator or catalyst. Another unique characteristic is that polybenzoxazines have greater molecular design flexibility than other polymers. They release no reaction by-product during polymerization, and no strong acid or alkaline catalysts are required for the synthesis of monomers or polymerization. However, some acids, such a phenols and carboxylic acids, will accelerate the rate of polymerization. Furthermore, no volatiles are released and almost no shrinkage is experienced upon polymerization.

The glass transition temperature of a polymer is an important material property associated with its response to temperature. At temperatures above the glass transition temperature, the mechanical properties of the polymer are reduced. ASTM D883 (Standard Terminology Relating to Plastics) defines the glass transition as “the reversible change in an amorphous polymer or in amorphous regions of a partially crystalline polymer from (or to) a viscous or rubbery condition to (or from) a hard and relatively brittle one.” Polymers with high glass transition temperatures have the advantage of being useful in applications requiring materials that can withstand higher continuous service temperatures. There is a need for polymers and polymer composites with higher glass transition temperatures.

Composite materials that are reinforced with continuous fibers are particularly advantageous for applications that require high strength and stiffness while maintaining low weight. A composite material is defined by ASTM D3878 (Standard Terminology for Composite Materials) as “a substance consisting of two or more materials, insoluble in one another, which are combined to form a useful engineering material possessing certain properties not possessed by the constituents.” Continuous fiber composites are those that contain fibers, or filaments, with high aspect ratios. Aspect ratio refers to the ratio of fiber length to fiber diameter. Examples of continuous fiber reinforcements include unidirectional tows, woven fabrics, and helical windings.

Composite materials often provide superior tensile strength, specific tensile strength, tensile modulus, and specific tensile modulus (stiffness) properties when compared to bulk materials. Specific tensile strength refers to the tensile strength divided by the density of the material. Specific tensile modulus refers to the tensile modulus divided by the density of the material.

Green composites comprised of bio-based resin and natural fiber reinforcement provide beneficial improvements in the areas of lightweighting and carbon footprint reduction compared to current materials such as metals and carbon fiber composites. Green composites have been described in the literature as composites that are comprised of “biopolymers (bio-derived polymers) reinforced with natural fibres.” [J. Duflou et al., MRS Bulletin, vol. 37, no. 1, p. 28 (2021)]. It is estimated that a 10% reduction in vehicle weight can provide a fuel efficiency improvement of 6% to 8% for conventional internal combustion engines or provide increased range for battery-electric vehicles by up to 10%. Carbon fiber composites are lightweight and provide excellent strength and stiffness but are very energy intensive to manufacture. Cumulative energy demand (CED) and carbon footprint for the production of flax fibers, a bio-based fiber, are significantly lower than those of carbon and glass fibers. Green composite materials derived from natural resources have the potential to substantially improve the efficiency of the transportation sector through lightweighting while also providing a reduction in carbon footprint when compared to carbon fiber and glass fiber reinforced composites.

End-of-life solutions for thermoset composites parts include landfill disposal, incineration, and recycling. Among these options, recycling is typically the most sustainable solution; however, this is typically challenging for thermosets. Traditional recycling approaches include mechanical (e.g., physical shredding), thermal (e.g., heat applied to break down waste for material separation or energy generation) and chemical (e.g., dissolving of the matrix in a reactive medium). Certain polymers and composites of this invention are recyclable due to the utilization of vitrimer functionality. Vitrimers may be heated and reshaped as part of the recycling process. Reshaping of vitrimers through the application of heat and pressure represents an additional approach to recycling of polymers and composites.

Polymers with reduced flammability are needed to meet performance requirements and regulations in a number of industries including transportation, aerospace, building and construction, consumer electronics, and electrical equipment. Flammability generally refers to the propensity of a substance to ignite easily and burn readily with a flame. The limiting oxygen index is a useful measure of a polymer's flammability that can be performed using only a small sample of material. The limiting oxygen index may be measured by an instrument, for example by means of ASTM D2863 “Standard Test Method for Measuring the Minimum Oxygen Concentration to Support Candle-Like Combustion of Plastics (Oxygen Index).”

International Application WO 2023/057568 to Verge et al. broadly discloses millions of benzoxazine compositions. Verge et al. explain that the glass transition temperature, Tg, of such polybenzoxazines may range from 25° C. to 300° C. They further state that bio-based reactants are preferable. However, this Application provides no information on the thermal stability, flammability, or mechanical properties of such polybenzoxazines or composites.

The patent LU101846 to Adjaoud et al. broadly discloses a large number of ester containing benzoxazine monomers. Adjaoud et al. explain that the glass transition temperature, Tg, of such polybenzoxazines may range from 25° C. to 300° C. and shows examples wherein the Tg is approximately 54° C. and 61° C. The patent also shows a polymer with a char yield at 800° C. of about 25%. The patent LU102318 to Adjaoud et al. also broadly discloses a large number of ester containing benzoxazine monomers.

### SUMMARY

Embodiments described herein relate to lightweight multifunctional polymers and composites, including resins from bio-based sources, and fiber reinforcement, including natural fibers. The resin may be designed at the molecular level for sourcing from natural materials, performance, ease of processability, and strong adhesion to fibers. Composites may be designed to provide high specific strength and modulus while being recyclable and having a low carbon footprint.

Materials described herein provide unique property profiles distinctly advantageous compared to alternative materials. Certain property profiles are particularly suitable for parts used in vehicles for transportation applications. In such applications, materials with high stiffness, low weight, low carbon footprint, and recyclability are particularly desirable.

In some embodiments, the resins described herein can include a benzoxazine resin that is cured to form a polybenzoxazine. The benzoxazine resin can have a structure of formula (I):

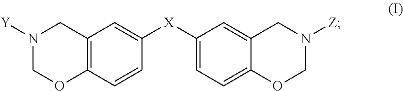

wherein at least one of the moieties X, Y, or Z includes at least one ester bond, and the polybenzoxazine formed by curing the benzoxazine resin has at least one of a char yield at 800° C. under an inert atmosphere of about 34% or higher, a limiting oxygen index of about 31 or higher, or a glass transition temperature of about 100° C. or higher.

In some embodiments, the benzoxazine resin is formed by reaction of a difunctional or multifunctional phenol with a primary amine or mixture of primary amines and an aldehyde.

In some embodiments, the primary amine includes furfurylamine, ethanolamine, 3-amino-1-propanol, 4-amino-1-butanol, 5-amino-1-pentanol, 6-amino-1-hexanol, and mixtures thereof.

In some embodiments, at least half of Y and/or Z have the structure of:

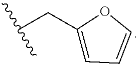 [SMILES: *Cc1ccco1]

In some embodiments, X has the structure of:

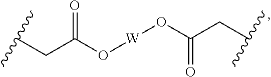

and
W is alkylene, cycloalkylene, alkylene-cycloalkylene, or alkylene-cycloalkylene-alkylene, each of which is optionally substituted with one or more halogen.

In other embodiments, the benzoxazine resin that is cured to form a polybenzoxazine can have a structure of formula (II):

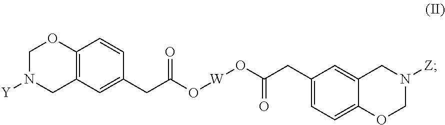

wherein
W is alkylene, cycloalkylene, alkylene-cycloalkylene, or alkylene-cycloalkylene-alkylene, each of which is optionally substituted with one or more halogen;
Y and Z are each independently-alkylene-furanyl or —(C₂-C₁₀ alkylene)-OH; and
the polybenzoxazine has at least one of a char yield at 800° C. under an inert atmosphere of about 34% or higher, a limiting oxygen index of about 31 or higher, or a glass transition temperature of about 100° C. or higher.

In some embodiments, at least half of Y and/or Z have the structure:

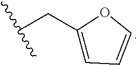 [SMILES: *Cc1ccco1]

In other embodiments, the benzoxazine resin has a structure of formula (III):

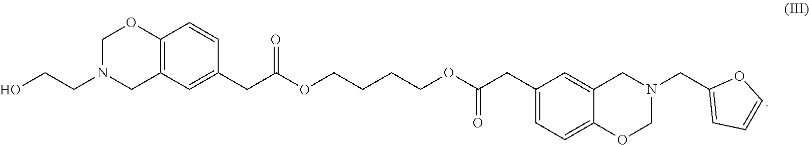 [SMILES: O=C(Cc1ccc2c(c1)CN(CCO)CO2)OCCCCOC(=O)Cc1ccc2c(c1)CN(Cc1ccco1)CO2]

In some embodiments, the benzoxazine resin of formula (I), (II), or (III) is cured by heating the benzoxazine resin of formula (I) or (II) to a temperature and for a duration of time effective to form the polybenzoxazine.

In other embodiments, the benzoxazine resin of formula (I), (II), or (III) is heated in the presence of an iron (III) chloride catalyst.

Still other embodiments relate to a material that includes:
a) about 5 to 95% by volume of a polybenzoxazine formed from curing a benzoxazine resin of formula (I), (II), or (III); and
b) about 95% to about 5% by volume of fibrous reinforcement.

Other embodiments relate to a material that includes a polybenzoxazine formed from curing a benzoxazine resin of formula (I), (II), or (III), wherein the material has a specific tensile modulus of about 14 GPa-cm³/g or higher.

Other embodiments relate to a material that includes a polybenzoxazine formed from curing a benzoxazine resin of formula (I), (II), or (III), wherein the material has a specific tensile strength of about 73 MPa-cm³/g or higher.

Other embodiments relate to a material that includes a polybenzoxazine formed from curing a benzoxazine resin of formula (I), (II), or (III), wherein the material has a specific flexural modulus of about 8 GPa-cm³/g or higher.

### BRIEF DESCRIPTION OF THE DRAWINGS

FIG. 1 is a TGA thermogram of poly(BHPA-f/ea) samples with and without catalyst.

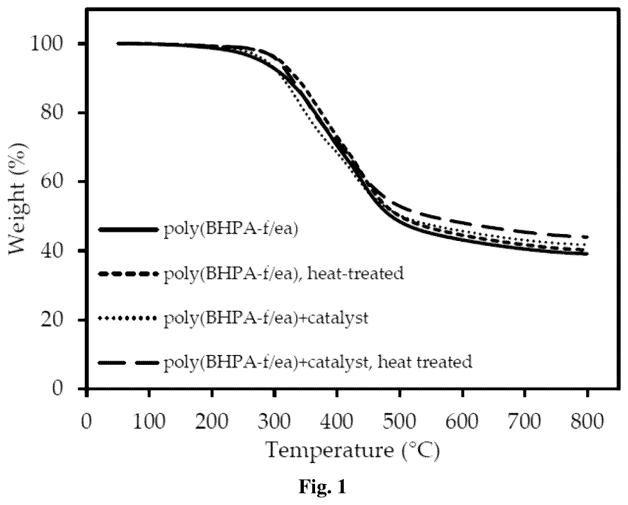

FIG. 2 is an exploded assembly drawing of the vacuum bagging setup used in Examples 6 and 9.

### DETAILED DESCRIPTION

While the following terms are believed to be well understood by one of ordinary skill in the art, the following definitions are set forth to facilitate explanation of the presently disclosed subject matter.

As used herein, the verb “comprise” as is used in this description and in the claims and its conjugations are used in its non-limiting sense to mean that items following the word are included, but items not specifically mentioned are not excluded.

Throughout this disclosure, where compositions are described as having, including, or comprising, specific components, it is contemplated that compositions also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the compositions and methods described herein remains operable. Moreover, two or more steps or actions can be conducted simultaneously.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

“Alkylene” refers to a fully saturated, straight or branched, divalent hydrocarbon chain radical, having from one to twelve carbon atoms. Non-limiting examples of C₁-C₁₂ alkylene include methylene, ethylene, propylene, n-butylene, ethenylene, propenylene, n-butenylene, propynylene, n-butynylene, and the like. The alkylene chain is attached to the rest of the molecule through a single bond and to the radical group through a single bond. The points of attachment of the alkylene chain to the rest of the molecule and to the radical group can be through one carbon or any two carbons within the chain. Unless stated otherwise specifically in the specification, an alkylene chain can be optionally substituted.

“Cycloalkylene” refers to a fully saturated cyclic or alicyclic divalent hydrocarbon chain radical, having from three to twelve carbon atoms. Non-limiting examples of C₃-C₁₂ cycloalkylene include cyclopropylene, cyclopentylene, cyclohexylene, cycloheptylene, cyclooctylene, alkyl substituted cycloalkylene groups, and cycloalkyl substituted alkylene groups and the like. The cycloalkylene is attached to the rest of the molecule through a single bond and to the radical group through a single bond. The points of attachment of the cycloalkylene to the rest of the molecule and to the radical group can be through one carbon or any two carbons within the chain. Unless stated otherwise specifically in the specification, a cycloalkylene chain can be optionally substituted.

The term “halo” or “halogen” refers to fluoro, chloro, bromo, and iodo.

As used herein, the symbol

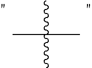

(hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example,

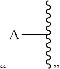

indicates that the chemical entity “A” is bonded to another chemical entity via the point of attachment bond. Furthermore, the specific point of attachment to the non-depicted chemical entity can be specified by inference. For example, the compound

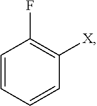

wherein X is

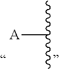

infers that the point of attachment bond is the bond by which X is depicted as being attached to the phenyl ring at the ortho position relative to fluorine.

Embodiments described herein relate to lightweight multifunctional polymers and composites, including resins from bio-based sources, and fiber reinforcement, including natural fibers. The resin may be designed at the molecular level for sourcing from natural materials, performance, ease of processability, and strong adhesion to fibers. Composites may be designed to provide high specific strength and modulus while being recyclable and having a low carbon footprint.

Materials described herein provide unique property profiles distinctly advantageous compared to alternative materials. Certain property profiles are particularly suitable for parts used in vehicles for transportation applications. In such applications, materials with high stiffness, low weight, low carbon footprint, and recyclability are particularly desirable.

In some embodiments, the resin can include a benzoxazine resin that is cured to form a polybenzoxazine. The benzoxazine resin can have a structure of formula (I):

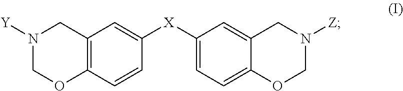

wherein the structure of formula (I) is formed from at least one bio-derived raw material, at least one of the moieties X, Y, or Z includes at least one ester bond, and the polybenzoxazine formed by curing the benzoxazine resin has at least one of a char yield at 800° C. under an inert atmosphere of about 34% or higher, a limiting oxygen index of about 31 or higher, or a glass transition temperature of about 100° C. or higher.

Such resins may be prepared by methods known in the art, for example, by the reaction of a difunctional phenol or multifunctional phenol with a primary amine, or a mixture of primary amines, in the presence of an aldehyde, such as formaldehyde.

In some embodiments, the primary amine includes furfurylamine or an amino-(C₂-C₁₂ alcohol), such as ethanolamine, 3-amino-1-propanol, 4-amino-1-butanol, 5-amino-1-pentanol, 6-amino-1-hexanol, and mixtures thereof, and reaction of the primary with a difunctional phenol and an aldehyde is such that Y and Z are each independently an -alkylene-furanyl or —(C₂-C₁₀ alkylene)-OH. As known in the art, when a mixture of primary amines is used the actual end moieties, Y and Z, of the structure of formula (I) will be a statistical distribution based on the reactions of the primary amines. The moieties Y and Z may be different, or they may be the same, i.e., Y═Z. For example, when the only primary amine used is ethanolamine, the corresponding moieties Y and Z are both —CH₂—CH₂OH.

In some embodiments, at least half of Y and/or Z have the structure of:

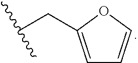 [SMILES: *Cc1ccco1]

In some embodiments, the difunctional phenol can be a bisphenol. Examples of bisphenols include bisphenol A (2,2-bis(4-hydroxyphenyl) propane), bisphenol AP (1,1-bis(4-hydroxyphenyl)-1-phenyl-ethane), bisphenol AF (2,2-bis(4-hydroxyphenyl) hexafluoropropane), bisphenol B (2,2-bis(4-hydroxyphenyl) butane), bisphenol BP (bis-(4-hydroxyphenyl)diphenylmethane), bisphenol C (bis(4-hydroxyphenyl)-2,2-dichloroethylene and also 2,2-bis(3-methyl-4-hydroxyphenyl) propane), bisphenol E (1,1-bis(4-hydroxyphenyl) ethane), bisphenol F (bis(4-hydroxyphenyl) methane), bisphenol G (2,2-bis(4-hydroxy-3-isopropylphenyl) propane), bisphenol M (4,4′-(1,3-phenylenediisopropylidene)bisphenol), bisphenol S (bis(4-hydroxyphenyl) sulfone), bisphenol P (4,4′-(1,4-phenylenediisopropylidene) bisphenol), bisphenol TMC (1,1-bis(4-hydroxyphenyl)-3,3,5-trimethylcyclohexane), and bisphenol Z (1,1-bis(4-hydroxyphenyl)-cyclohexane), including any combination or subset of the above.

In other embodiments, where X includes an ester group, a difunctional phenol including a first and second phenol separated by a linker that includes at least one ester group can react with the primary amine or mixture of primary amines in the presence of an aldehyde, such as formaldehyde, to provide a structure of formula (II) where X includes the ester.

In some embodiments, X has the structure of:

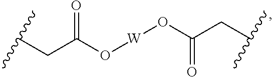

wherein W is alkylene, cycloalkylene, alkylene-cycloalkylene, or alkylene-cycloalkylene-alkylene, each of which is optionally substituted with one or more halogen.

In other embodiments, the benzoxazine resin, which is cured to form a polybenzoxazine, can have a structure of formula (II):

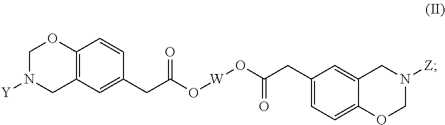

wherein
W is alkylene, cycloalkylene, alkylene-cycloalkylene, or alkylene-cycloalkylene-alkylene, each of which is optionally substituted with one or more halogen;
Y and Z are each independently-alkylene-furanyl or —(C₂-C₁₀ alkylene)-OH; and
the polybenzoxazine has at least one of a char yield at 800° C. under an inert atmosphere of about 34% or higher, a limiting oxygen index of about 31 or higher, or a glass transition temperature of about 100° C. or higher.

In some embodiments, the benzoxazine resin of formula (II) is formed from at least one bio-derived raw material. Such benzoxazine resins may be prepared by first reacting a diol with 4-hydroxyphenylacetic acid to obtain a difunctional monomer with two ester groups. Examples of diols that can be used include ethylene glycol, 1,3-propanediol, 1,4-butanediol, 1,5-pentanediol, 1,6-hexanediol, 1,4-cyclohexanediol, cyclohexanedimethanol, neopentyl glycol, and 2,2,4,4-tetramethyl-1,3-cyclobutanediol.

In some embodiments, when the diol reacted with 4-hydroxyphenylacetic acid is 1,4-butanediol, the corresponding moiety W is —CH₂—CH₂—CH₂—CH₂—. Similarly, when the diol reacted with 4-hydroxyphenylacetic acid is 1,6-hexanediol, the corresponding moiety W is —(CH₂)₆—.

The difunctional monomer obtained by reaction with the acid may then be reacted with a primary amine or mixture of primary amines in the presence of an aldehyde, such as formaldehyde, to obtain a benzoxazine resin of formula (II).

In some embodiments, the primary amine includes furfurylamine or an amino-(C₂-C₁₂ alcohol), such as ethanolamine, 3-amino-1-propanol, 4-amino-1-butanol, 5-amino-1-pentanol, 6-amino-1-hexanol, and mixtures thereof, and reaction of the primary with a difunctional phenol and an aldehyde is such that Y and Z are each independently an -alkylene-furanyl or —(C₂-C₁₀ alkylene)-OH. The moieties Y and Z may be different, or they may be the same, i.e., Y═Z. For example, when the only primary amine used is ethanolamine, the corresponding moieties Y and Z are both —CH₂—CH₂OH.

In some embodiments, at least half of Y and/or Z have the structure of:

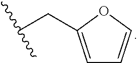 [SMILES: *Cc1ccco1]

In other embodiments, the benzoxazine resin, which is cured to form a polybenzoxazine, can have a structure of formula (III):

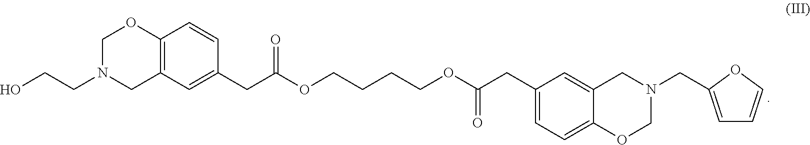 [SMILES: O=C(Cc1ccc2c(c1)CN(CCO)CO2)OCCCCOC(=O)Cc1ccc2c(c1)CN(Cc1ccco1)CO2]

This benzoxazine resin may be prepared by first reacting 1,4-butanediol with 4-hydroxyphenylacetic acid to obtain butane-1,4-diyl bis(2-(4-hydroxyphenyl)) acetate as shown below.

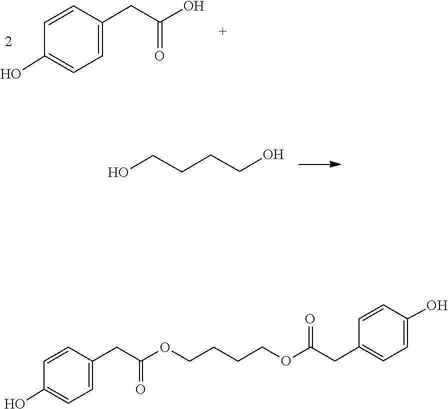 [SMILES: O=C(O)Cc1ccc(O)cc1 ; OCCCCO ; O=C(Cc1ccc(O)cc1)OCCCCOC(=O)Cc1ccc(O)cc1]

This is a diol with two ester groups. The diol may then be reacted with furfurylamine and ethanolamine in the presence of formaldehyde to obtain a benzoxazine resin of formula (III) as shown below.

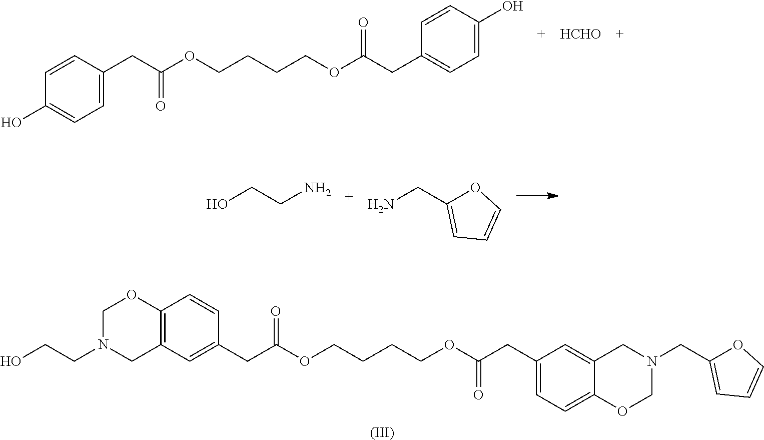

The result is a viscous liquid resin, abbreviated as BHPA-f-ea. As known in the art, the actual end moieties of the molecule illustrated as formula (III) will be a statistical distribution based on the reactions of furfurylamine and ethanolamine. The benzoxazine resin of formula (III) also illustrates a material synthesized with bio-derived raw materials. The raw material 1,4-butanediol may be synthesized through the fermentation of sugars from biomass, such as corn and wheat straw. The raw material 4-hydroxyphenylacetic acid occurs widely in nature, such as in olives, cocoa beans, oats, and mushrooms. material 4-hydroxyphenylacetic acid may also be synthesized from lignin-related p-coumaric and ferulic acid. Furfurylamine may be synthesized from furfural, a renewable resource derived from corncobs, sugar cane, and wheat. Derivatives of ethanolamine are widespread in nature, for example, in lipids. Ethanolamine may be produced by reductive amination of biomass-derived aldehydes and ketones.

Embodiments described herein further include polybenzoxazines prepared by polymerization, or curing, of benzoxazine resins, such as benzoxazine resins having structures (I), (II), and/or (III). Curing is defined by ASTM D883 as a method used “to change the properties of a polymeric system into a more stable, usable condition by the use of heat, radiation, or reaction with chemical additives.” Curing may be accomplished by heating the resin, typically in a mold. Curing results in polymerization primarily through opening of the oxazine ring. Curing may result in opening of some or all of the oxazine rings in the material. Curing may be accomplished with or without a catalyst and with or without an initiator. One suitable catalyst is iron (III) chloride, which is effective in the range of 0.1 to 5.0 mol %, and more preferably in the range of 0.1 to 3.0 mol %. Post-cure heat treatment of parts has been found to be beneficial in terms of increasing the glass transition temperature of the polymer. Exemplary embodiments have been post-cured in a convection oven, in a furnace, or on a hotplate. Heat treatment times in the range of 5 minutes to 4 hours at temperatures in the range of about 240° C. to about 500° C. have been found to be effective. Post-cure heat treatment is illustrated within the Examples presented below.

There are various methods known in the art for measuring the glass transition temperature (Tg) of a polymer. For example, differential scanning calorimetry (DSC) may be used to determine the Tg. ASTM Standard D3418 (Standard Method for Transition Temperatures and Enthalpies of Fusion and Crystallization of Polymers by Differential Scanning calorimetry) presents such methods. Also, dynamic mechanical analysis may be used to determine the Tg. ASTM D7028 (Standard Test Method for Glass Transition Temperature (DMA Tg) of Polymer Matrix Composites by Dynamic Mechanical Analysis (DMA)) presents one such method. The Tg determined from DMA data is also dependent on the method of evaluating the data. ASTM D7028 defines the glass transition temperature as the “DMA Tg”. The DMA Tg is determined by plotting the logarithm of the storage modulus (E′) and constructing two lines that are tangent to the curve in accordance with instructions provided in ASTM D7028. The temperature at the intersection of the tangent lines is defined as the DMA Tg. Other definitions for the Tg that are commonly used include the tan delta peak (i.e., a peak in the tan delta curve) and/or the loss modulus peak (i.e., a peak in the loss modulus curve). In some instances, a material may not exhibit a glass transition temperature below its thermal degradation temperature.

Other embodiments described herein include polymers and composites with unexpectedly high glass transition temperatures. Examples of composites with glass transition temperatures greater than 100° C., and in some instances greater than 120° C., are described within the Examples below.

Still other embodiments relate to the ability to adjust the properties of the cured polybenzoxazines through heat treatment after curing. In particular, heat treatment has been found to dramatically increase the Tg of the material. Heat treatment of exemplary cured composites of the present invention has been demonstrated to increase the Tg by 30° C. or more. The amount of increase in the Tg is especially dependent on the temperature of the heat treatment and somewhat dependent on the time. Thus, the Tg and other properties of a material may be selectively modified by post-cure heat treatment.

Still other embodiments relate to polymers and composites with unexpectedly good thermal stability and flammability characteristics. Char yield after heating to a high temperature is one indicator of thermal stability. The limiting oxygen index is an indicator of the flammability of the material

Other embodiments relate to polymer matrix composites prepared using the benzoxazine resins of formulas (I), (II), or (III). Composites may include a variety of reinforcements known in the art. Reinforcements may be added to improve mechanical properties and/or to achieve other property improvements. Reinforcing fibers, also referred to as filaments, may or may not be continuous fibers. The Composite Materials Handbook, Vol. 1 (2012) defines a continuous filament as “[a] yarn or strand in which the individual filaments are substantially the same length as the strand.” Continuous fiber reinforcement is preferred for even more advantageous mechanical properties. One preferred type of fiber reinforcement is bio-based fibers, such as flax fibers. Composite embodiments described herein have advantageous specific tensile modulus, specific tensile strength, and specific flexural modulus compared to alternative materials. Composite embodiments described herein have unexpectedly high specific tensile modulus, specific tensile strength, and/or specific flexural modulus.

Other embodiments described herein relate to a material that includes 1% to 99% by weight of a polybenzoxazine formed by cure of a benzoxazine of a resin of structure (I), (II), or (III) as described above.

Still another aspect relates to a material, comprising:
a) 5 to 95% by volume of a polybenzoxazine formed by cure of a benzoxazine resin of the structure (I), (II), or (III) as described above; and
b) 95% to 5% by volume of fibrous reinforcement.

In a preferred aspect, the fibrous reinforcement comprises a continuous fiber or a woven continuous fiber, such as a bio-based fiber.

Various additives and/or modifiers may be included in the materials described herein. Additives and modifiers may include stabilizers, ultraviolet (UV) stabilizers, antioxidants, scavengers, lubricants, processing aids, antimicrobials, flame retardants, anti-blocking additives, antistatic additives, colorants, whitening agents, coupling agents, and other additives and modifiers known in the art. Fillers and reinforcements may be added. Nanoparticles may be included.

This invention can be further illustrated by the following examples of embodiments thereof, although it will be understood that these examples are included merely for purposes of illustration and are not intended to limit the scope of the invention unless otherwise specifically indicated.

### EXAMPLES

### Example 1: Synthesis of BHPA-f/ea Benzoxazine

This example describes the synthesis of BHPA-f/ea benzoxazine resin using a two-step process. In the first step, an ester was synthesized. To synthesize the ester, 4-hydroxy phenyl acetic acid and 1,4-butandiol were combined in a 2:1 mol ratio, respectively, and dissolved in ethyl acetate for 30 mins at room temperature. Five drops of catalyst (H₂SO₄) were added and the mixture was kept under reflux for 72 hours at 45° C. The solution was allowed to cool at room temperature and washed with 1M sodium bicarbonate solution to maintain the pH. Finally, the organic layer containing the ester was collected and used for further synthesis as described below in step 2. Scheme 1 shows the synthesis reaction for ester formation. Yield was approximately 99%.

Synthesis of the benzoxazine was performed using a 4:1:1:1 mol ratio of paraformaldehyde, the prepared ester in ethyl acetate (from step 1), furfurylamine, and ethanolamine, respectively. The reactants were added to the prepared ester in ethyl acetate and mixed for 15 minutes at room temperature. The mixture was then kept under reflux for 72 hours at 60° C. The organic layer was then washed with water six times. The organic layer was collected and an appropriate amount of anhydrous magnesium sulfate was added and the mixture kept overnight at room temperature. Finally, the solvent was evaporated by heating the product for 8 hours at 50° C., leaving a viscous liquid resin, abbreviated as BHPA-f/ea. Yield was approximately 70%. The resulting product was stored in a refrigerator at approximately 3° C. The resin was polymerized by different means, including the means described in Examples that follow.

### Example 2: Polymerization of BHPA-f/ea Benzoxazine

This example describes the polymerization of BHPA-f/ea benzoxazine resin prepared by the method of Example 1. Approximately 5 grams of BHPA-f/ea solution, comprised of approximately 30 wt. % BHPA-f/ea resin and 70 wt. % ethyl acetate, was removed from a storage jar and added to a silicone mold using a pipette. The mold was placed in a vacuum oven at room temperature. A vacuum of approximately 760 mm of mercury (Hg) was applied and held for 24 hours to remove the solvent and moisture. The vacuum was released and the oven temperature was increased to approximately 170° C. The temperature was held at 170° C. for 2 hours. The mold was removed from the oven and allowed to cool at room temperature. The molded part was removed from the mold and found to be a solid polymer with a density of approximately 1.24 g/cm³ (as determined in accordance with ASTM D792).

### Example 3: Preparation of BHPA-f/ea Benzoxazine Containing FeCl₃ Catalyst

This example describes the preparation of a batch of BHPA-f/ea resin, prepared by the method of Example 1, containing approximately 3 mol % FeCl₃ catalyst. The molar ratio of resin to catalyst refers to the solids ratio after any solvents have been removed. Approximately 5 grams of BHPA-f/ea solution, comprised of approximately 30 wt. % BHPA-f/ea resin and 70 wt. % ethyl acetate, was removed from a storage jar and added to a silicone mold using a pipette. Approximately 3 mol % of 0.2M FeCl₃ solution in 2-methyltetrahydrofuran was added to the silicone mold using a graduated pipette. The mixture of BHPA-f/ea solution and 0.2M FeCl₃ solution was mechanically mixed for 10 minutes using a glass rod.

### Example 4: Polymerization of BHPA-f/ea Benzoxazine Containing FeCl₃ Catalyst

This example describes the polymerization of catalyzed BHPA-f/ea benzoxazine resin prepared by the method of Example 3. The mold from Example 3 containing approximately 5 grams of BHPA-f/ea solution with approximately 3 mol % FeCl₃ catalyst was placed in a vacuum oven at room temperature. A vacuum of approximately 760 mm of mercury (Hg) was applied and held for 24 hours to remove the solvent and moisture. The vacuum was released and the oven temperature was increased to approximately 170° C. The temperature was held at 170° C. for 2 hours. The mold was removed from the oven and allowed to cool at room temperature. The molded part was removed from the mold and found to be a solid polymer with a density of approximately 1.24 g/cm³ (as determined in accordance with ASTM D792).

### Example 5: Prepregs of Flax Fiber Fabric and poly(BHPA-f/ea) Containing Cellulose Nanofibrils

This example describes the preparation of prepregs comprised of flax fiber fabric and BHPA-f/ea resin containing 1.0 wt. % cellulose nanofibrils. The mass ratio of resin to cellulose nanofibrils refers to the solids ratio after any solvents have been removed. To prepare the prepregs, six swatches of flax fiber fabric, approximately 15.2×15.2 cm in size, were obtained from a larger roll fabric using a handheld rotary cutter. The total dry mass of the six fabric swatches was 52.6 grams. The fabric was comprised of 2×2 twill woven flax fibers with areal density as 365 g/m². The density of the flax fiber is reported as 1.35 g/cm³ by the manufacturer.

The target loading of resin in the prepregs was 50 wt. %. Approximately 28.9 grams of BHPA-f/ea solution, comprised of approximately 30 wt. % BHPA-f/ea resin and 70 wt. % ethyl acetate, was removed from a storage jar and added to a glass beaker using a glass pipette. Approximately 2.6 grams of nanofibril slurry (University of Maine, Standard Slurry) having a solids content of approximately 3.4 wt. % and water content of approximately 96.6%, was added to the beaker using a glass pipette. Approximately 60 mL of acetone was then added to the mixture. The amount of acetone added was roughly two times the volume of resin solution that was previously added to the beaker. The mixture was stirred for 15 minutes at room temperature until the nanofibrils were observed to be well dispersed. Five additional batches of resin containing 1.0 wt. % cellulose nanofibrils were prepared by repeating the previous steps.

The mixture of resin solution and nanofibrils was applied to the surfaces of the six flax fiber fabric swatches using a glass pipette. The mixture was distributed evenly between the surfaces of the six fabric swatches and applied in several steps so as to not oversaturate the fabric. Approximately 10-15 minutes of drying time was allowed under a fume hood between applications. After the final application, the prepregs were placed into a vacuum oven and dried at room temperature for 24 hours under a vacuum of approximately 760 mm Hg. The average mass of resin in the prepregs after drying was 53.6%.

### Example 6: Molded Composite of Flax Fiber Fabric and poly(BHPA-f/ea) Containing Cellulose

### Nanofibrils

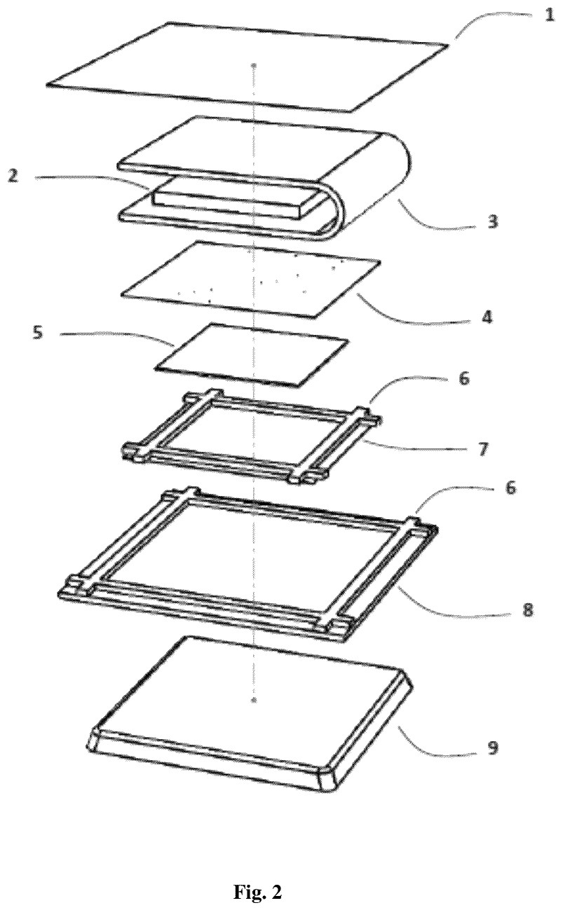

This example describes the fabrication of a 15.2×15.2 cm composite plate using the flax fiber prepregs that were previously prepared in Example 5. Consolidation and polymerization of the composite were achieved by simultaneously applying vacuum and heat while sealed in a vacuum bagged mold, as illustrated in FIG. 2. A one-sided mold was constructed using a 30.5×30.5×1.0 cm polished aluminum plate 8, vacuum bagging film 1, perforated release film 4, non-perforated release film 7, breather/bleeder cloth 3, vacuum sealing tape 6 and a 10×10×1.0 cm aluminum pressure plate 2 according to the schematic provided in FIG. 2. The un-cured prepregs 5 were hand laid into the mold during assembly. Vacuum tubing was connected to the mold using a through-bag vacuum fitting placed below the vacuum bagging film and on top of the breather/bleeder cloth. Full vacuum of approximately 760 mm Hg was applied 24 hours prior to the start of the polymerization cycle.

The aluminum plate was heated by placing it directly on the surface of a hotplate with a 26×26 cm ceramic top 9. Composite temperature was monitored using a thermocouple that was placed on the surface of the aluminum plate under a corner of the composite. The composite was polymerized using a cure schedule of 2 hours and 30 minutes at a hotplate setpoint of 200° C., which included the 30 minutes required to ramp the mold temperature from room temperature to a steady-state temperature. The maximum temperature reached by the composite, according to the thermocouple, was 192.9° C. After completion of the polymerization cycle, the hot plate was turned off and the mold was allowed to cool. Vacuum was continuously applied during cooling to prevent warping of the composite. Vacuum was released once the thermocouple temperature dropped below 60° C.

The composite plate was inspected after removal from the mold. It appeared to be fully polymerized and showed no signs of defects. The plate was flat with a nominal thickness of 3.6 mm. The mass of the resulting composite plate was approximately 85.8 grams. Based on the known mass of the dry fabric reinforcement, the mass fractions of poly(BHPA-f/ea) and flax fiber reinforcement in the composite were calculated to be approximately 38.7% and 61.3%, respectively. A rectangular sample, approximately 60×12 mm in size, was cut from the composite plate using a table saw equipped with a fine tooth saw blade and designated as “Sample A.”

### Example 7: Post-Cure Heat Treatment of Composite of Flax Fiber Fabric and poly(BHPA-f/ea)

### Containing Cellulose Nanofibrils

This example describes the process of heat treating samples of the composite plate that was prepared previously in Example 6. Samples, approximately 60×12 mm in size, were cut from the composite plate using a table saw with a fine-tooth blade. Heat was applied to the composite samples using a laboratory convection oven. The composite samples were placed into the preheated oven and then removed after the specified heat treatment time had elapsed. The samples were then allowed to cool to room temperature. One sample was heat treated for 1 hour at 200° C. and was designated as “Sample B.” One sample was heated for 1 hour at 220° C. and was designated as “Sample C.”

### Example 8: Prepregs of Flax Fiber Fabric and poly(BHPA-f/ea) Containing Cellulose Nanofibrils and FeCl₃ Catalyst

This example describes the preparation of prepregs comprised of flax fiber fabric and BHPA-f/ea resin containing 1 wt. % cellulose nanofibrils and 3 mol % FeCl₃ catalyst. The mass ratio of resin to cellulose nanofibrils refers to the solids ratio after any solvents have been removed. The molar ratio of resin to catalyst refers to the solids ratio after any solvents have been removed. To prepare the prepregs, four swatches of flax fiber fabric, approximately 25.4×25.4 cm in size, were obtained from a larger roll fabric using a handheld rotary cutter. The total dry mass of the four fabric swatches was 96.4 grams. The fabric was purchased from a commercial source and was comprised of 2×2 twill woven flax fibers. The fabric technical specification identifies the areal density as 365 g/m². The density of the flax fiber is reported as 1.35 g/cm³ by the manufacturer.

The target loading of resin in the prepregs was 50 wt. %. Approximately 28.2 grams of BHPA-f/ea solution, comprised of approximately 86 wt. % BHPA-f/ea resin and approximately 14 wt. % ethyl acetate, was removed from a storage jar and added to a glass beaker using a glass pipette. Approximately 7.2 grams of nanofibril slurry (University of Maine, Standard Slurry), having a solids content of approximately 3.4 wt. % and water content of approximately 96.6%, was added to the beaker using a glass pipette. Approximately 40 mL of acetone was then added to the mixture. The amount of acetone added was roughly two times the volume of resin solution that was previously added to the beaker. The mixture was stirred for 15 minutes at room temperature until the nanofibrils were observed to be well dispersed. Approximately 5.4 grams of 0.2M FeCl₃ solution in 2-methyltetrahydrofuran was added to the mixture. The mixture was stirred for 15 minutes at room temperature. Three additional batches of resin containing 1 wt % cellulose nanofibrils and 3 mol % FeCl₃ catalyst were prepared by repeating the previous steps.

The mixture was applied to the surfaces of the four flax fiber fabric swatches using a glass pipette. The mixture was distributed evenly between the surfaces of the four fabric swatches and applied in several steps so as to not oversaturate the fabric. Approximately 10-15 minutes of drying time was allowed under a fume hood between applications. After the final application, the prepregs were placed into a vacuum oven and dried at room temperature for 24 hours under a vacuum of approximately 760 mm Hg. The average mass of resin in the prepregs after drying was 48.6%.

### Example 9: Molded Composite of Flax Fiber Fabric and poly(BHPA-f/ea) Containing Cellulose

### Nanofibrils and FeCl₃ Catalyst.

This example describes the fabrication of a 25.4×25.4 cm composite plate using the flax fiber prepregs that were previously prepared in Example 8. Consolidation and polymerization of the composite were achieved by simultaneously applying vacuum and heat while sealed in a vacuum-bagged mold, as illustrated in FIG. 2. Components of the mold used in this example were the same as those described previously in Example 6. The un-cured prepregs were hand laid into the mold during assembly. Vacuum tubing was connected to the mold using a through-bag vacuum fitting as described previously in Example 6.

The aluminum plate was heated by placing it directly on the surface of a hotplate with a 26×26 cm ceramic top. Composite temperature was monitored using a thermocouple that was placed on the surface of the aluminum plate under a corner of the composite. The composite was polymerized using a cure schedule of 2 hours and 45 minutes at a hotplate setpoint of 190° C., which included the 45 minutes required to ramp the mold temperature from room temperature to a steady-state temperature. The maximum temperature reached by the composite, according to the thermocouple, was 176.5° C. After completion of the polymerization cycle, the hot plate was turned off and the mold was allowed to cool. Vacuum was continuously applied during cooling to prevent the composite from warping. Vacuum was released once the thermocouple temperature dropped below 60° C.

The composite plate was inspected after removal from the mold. It appeared to be fully polymerized and showed no signs of defects. The plate was flat with a nominal thickness of 2.5 mm. The mass of the resulting composite plate was approximately 163.2 grams. Based on the known mass of the dry fabric reinforcement, the mass fractions of poly(BHPA-f/ea) and flax fiber reinforcement in the composite were calculated to be approximately 40.9% and 59.1%, respectively. A rectangular sample, approximately 60×12 mm in size, was cut from the composite plate using a table saw equipped with a fine-tooth saw blade and designated as “Sample D.”

### Example 10: Dynamic Mechanical Analysis of Composites of Flax Fiber Fabric and poly(BHPA-f/ea)

This example describes dynamic mechanical analysis (DMA) testing of composite samples. Rectangular samples, approximately 60×12 mm in size, were previously cut from composite plates and designated as Samples A through D, as described in Examples 6, 7, and 9. All samples were tested using a TA Instruments model Q800 DMA equipped with a dual cantilever fixture. Test parameters were guided by ASTM D7028. Samples were tested at a constant strain amplitude of 0.1% and frequency of 1.0 Hz. Temperature was ramped from room temperature to a maximum value of 300° C. at a rate of 5° C./minute.

The composite sample, designated as “Sample A”, that was cut from the composite plate prepared in Example 6 with no heat treatment was tested by DMA to determine its glass transition temperature. The sample was tested to a maximum temperature of 300° C. using the parameters described above. The DMA Tg, loss modulus peak, and tan delta peak were found to be 58.6° C., 73.7° C., and 118.2° C., respectively.

The composite sample, designated as “Sample B”, that was cut from the composite plate prepared in Example 6 and heat treated for 1 hour at 200° C. in Example 7 was tested by DMA to determine its glass transition temperature. The sample was tested to a maximum temperature of 300° C. using the parameters described above. The DMA Tg, loss modulus peak, and tan delta peak were found to be 112.8° C., 126.1° C., and 150.6° C., respectively.

The composite sample, designated as “Sample C”, that was cut from the composite plate prepared in Example 6 and heat treated for 1 hour at 220° C. in Example 7 was tested by DMA to determine its glass transition temperature. The sample was tested to a maximum temperature of 300° C. using the parameters described above. The DMA Tg, loss modulus peak, and tan delta peak were found to be 128.3° C., 146.4° C., and 162.6° C., respectively.

The composite sample, designated as “Sample D”, that was cut from the composite plate prepared in Example 9 with no heat treatment was tested by DMA to determine its glass transition temperature. The sample was tested to a maximum temperature of 300° C. using the parameters described above. The DMA Tg, loss modulus peak, and tan delta peak were found to be 115.6° C., 133.5° C., and 149.2° C., respectively. The DMA thermogram for Sample D is shown in FIG. 3.

Results from the DMA testing are summarized below in Table 1.

TABLE 1
Summary of DMA Testing Results

| Sample ID | Sample A | Sample B | Sample C | Sample D |
|---|---|---|---|---|
| Catalyst | None | None | None | 3 mol % |
| | | | | FeCl₃ |
| Heat Treatment | None | 1 hr | 1 hr | None |
| | | at 200° C. | at 220° C. | |
| DMA Tg | 58.6° C. | 112.8° C. | 128.3° C. | 115.6° C. |
| Loss Modulus Peak | 73.7° C. | 126.1° C. | 146.4° C. | 133.5° C. |
| Tan Delta Peak | 118.2° C. | 150.6° C. | 162.6° C. | 149.2° C. |

### Example 11: Reshaping of Composite of Flax Fiber Fabric and poly(BHPA-f/ea) Containing

### Cellulose Nanofibrils and FeCl₃ Catalyst

This example describes the process of reshaping a sample of the flat composite plate that was prepared previously in Example 9 into a contoured plate. A rectangular sample, approximately 123×34 mm in size, was cut from the composite plate that was prepared previously in Example 9 using a table saw equipped with a fine-tooth blade. The composite sample was placed onto a contoured aluminum mold that had been sprayed with mold release. A thermocouple was placed in contact with the aluminum mold to monitor the mold temperature. A piece of perforated release film was placed on top of the composite sample. A piece of breather cloth was placed on top of the release film. The composite sample was then sealed against the mold surface using a piece of vacuum bagging film and vacuum tape. Vacuum tubing was connected to the mold using a through-bag vacuum fitting placed below the vacuum bagging film and on top of the breather cloth. The mold was heated on a hotplate with a setpoint of 190° C. A vacuum of approximately 760 mm Hg was applied once the thermocouple temperature reached 180° C. The composite sample was heated and held under vacuum for 30 minutes. After 30 minutes, the hotplate was turned off and the mold was allowed to cool to 60° C. prior to releasing the vacuum and removing the composite from the mold. The composite was inspected after removal from the mold and found to have changed shape. The composite was successfully reshaped from a flat plate to a contoured plate.

### Example 12: Thermogravimetric Analysis and Determination of the Limiting Oxygen Index

The thermal stability of poly(BHPA-f/ea) with and without catalyst was evaluated using thermogravimetric analysis (TGA). The addition of catalyst (3 mol % FeCl₃) was shown to improve thermal stability of the polymer in terms of both decomposition onset and final char yield. The char yield (CR) was defined as the amount of carbonaceous residue remaining under an inert atmosphere at 800° C. The char yield was measured as 34.1% for the uncatalyzed polymer and 59.8% for the catalyzed polymer. The limiting oxygen index (LOI) value for the polymer was estimated using the van Krevelen equation where LOI=17.5+0.4 (CR). The estimated LOI values for the uncatalyzed and catalyzed polymers were thus calculated as 31.1 and 41.4, respectively. Studies have shown that LOI values greater than 28 indicate that a polymer is self-extinguishing, although some studies suggest the cutoff value to be 26. The materials tested here can be considered self-extinguishing, with the catalyzed polymer providing a greater degree of flame retardancy than the uncatalyzed polymer.

### Example 13: Specific Tensile Modulus and Specific Tensile Strength of Composites

The tensile properties of woven-flax/poly(BHPA-f/ea) composites and unidirectional-flax/poly(BHPA-f/ea) composites were measured in accordance with ASTM D3039. A crosshead speed of 2.0 mm/min was used for all specimens. Six specimens were tested per composite sample. Strain was measured by digital image correlation. Testing of the woven flax composite was conducted with the tensile direction parallel to the warp threads. Testing of the unidirectional flax composite was conducted with the tensile direction parallel to the fibers. The specific tensile modulus (tensile modulus divided by the density) was found to be 14 GPa-cm³/g for the woven-flax/poly(BHPA-f/ea) composite and 20 GPa-cm³/g for the unidirectional-flax/poly(BHPA-f/ea) composite. The specific tensile strength (tensile strength divided by the density) was found to be 73 MPa-cm³/g for the woven-flax/poly(BHPA-f/ea) composite and 139 MPa-cm³/g for the unidirectional-flax/poly(BHPA-f/ea) composite.

### Example 14: Specific Flexural Modulus of Composites

The flexural properties of woven-flax/poly(BHPA-f/ea) composites and unidirectional-flax/poly(BHPA-f/ea) composites were measured in accordance with ASTM D790, Procedure A, using a three-point bending fixture. The radii of the fixture's loading nose and supports were 5.0 mm. The woven flax composite specimens were tested using a span-to-thickness ratio of 16:1. The unidirectional flax composite specimens were tested using a span-to-thickness ratio of 32:1. Six specimens were tested per composite sample. Testing of the woven flax composite was conducted with the long direction of the specimen parallel to the warp threads. Testing of the unidirectional flax composite was conducted with the long direction of the specimen parallel to the fibers. The specific flexural modulus (flexural modulus divided by the density) was found to be 8 GPa-cm³/g for the woven-flax/poly(BHPA-f/ea) composite and 17 GPa-cm³/g for the unidirectional-flax/poly(BHPA-f/ea) composite.

For the avoidance of doubt, it is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition and process according to the invention are described herein.

While this invention has been particularly shown and described with references to preferred embodiments thereof, it will be understood by those skilled in the art that various changes in form and details may be made therein without departing from the scope of the invention encompassed by the appended claims. All patents, publications and references cited in the foregoing specification are herein incorporated by reference in their entirety.

We claim:

1. A polybenzoxazine comprising:
a cured benzoxazine resin, wherein the benzoxazine resin has a structure of formula (I): 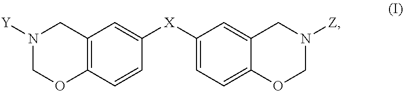
at least one of the moieties X, Y, or Z includes at least one ester bond, and the polybenzoxazine has at least one of a char yield at 800° C. under an inert atmosphere of about 34% or higher, a limiting oxygen index of about 31 or higher, or a glass transition temperature of about 100° C. or higher.

2. The polybenzoxazine of claim 1, wherein the benzoxazine resin is formed by reaction of a difunctional or multifunctional phenol with a primary amine or mixture of primary amines, and an aldehyde.

3. The polybenzoxazine of claim 2, wherein the primary amine includes furfurylamine, ethanolamine, 3-amino-1-propanol, 4-amino-1-butanol, 5-amino-1-pentanol, 6-amino-1-hexanol, and mixtures thereof.

4. The polybenzoxazine of claim 1, wherein at least half of Y and/or Z have the structure of:

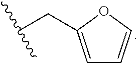 [SMILES: *Cc1ccco1]

5. The polybenzoxazine of claim 1, wherein X has the structure of: 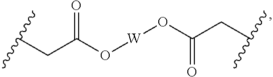
and
W is alkylene, cycloalkylene, alkylene-cycloalkylene, or alkylene-cycloalkylene-alkylene, each of which is optionally substituted with one or more halogen.

6. The polybenzoxazine of claim 1, wherein benzoxazine resin is cured by heating the benzoxazine resin to a temperature and for a duration of time effective to form the polybenzoxazine.

7. The polybenzoxazine of claim 6, wherein the benzoxazine resin is heated in the presence of an iron (III) chloride catalyst.

8. A material comprising:
a) about 5 to 95% by volume of a polybenzoxazine of claim 1; and
b) about 95% to about 5% by volume of fibrous reinforcement.

9. A material comprising a polybenzoxazine of claim 1, wherein the material has a specific tensile modulus of about 14 GPa-cm³/g or higher.

10. A material comprising: a polybenzoxazine of claim 1, wherein the material has a specific tensile strength of about 73 MPa-cm³/g or higher.

11. A material comprising: a polybenzoxazine of claim 1, wherein the material has a specific flexural modulus of about 8 GPa-cm³/g or higher.

12. A polybenzoxazine comprising:
a cured benzoxazine resin, wherein the benzoxazine resin has a structure of formula (II) 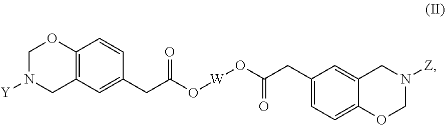
W is alkylene, cycloalkylene, alkylene-cycloalkylene, or alkylene-cycloalkylene-alkylene, each of which is optionally substituted with one or more halogen;
Y and Z are each independently-alkylene-furanyl or —(C₂-C₁₀ alkylene)-OH; and
wherein the polybenzoxazine has at least one of a char yield at 800° C. under an inert atmosphere of about 34% or higher, a limiting oxygen index of about 31 or higher, or a glass transition temperature of about 100° C. or higher.

13. The polybenzoxazine of claim 12, wherein at least half of Y and/or Z have the structure:

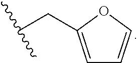 [SMILES: *Cc1ccco1]

14. The polybenzoxazine of claim 12, wherein the benzoxazine resin has a structure of formula (III):

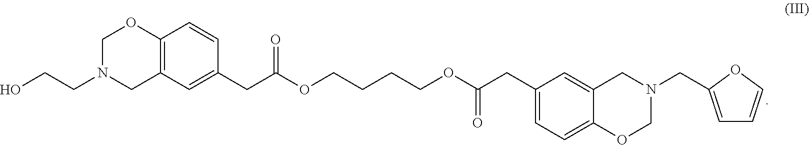 [SMILES: O=C(Cc1ccc2c(c1)CN(CCO)CO2)OCCCCOC(=O)Cc1ccc2c(c1)CN(Cc1ccco1)CO2]

15. The polybenzoxazine of claim 12, wherein benzoxazine resin of structure (II) is cured by heating the benzoxazine resin of structure (II) to a temperature and for a duration of time effective to form the polybenzoxazine.

16. The polybenzoxazine of claim 15, wherein the benzoxazine resin of structure (II) is heated in the presence of an iron (III) chloride catalyst.

17. A material comprising:
a) about 5 to 95% by volume of a polybenzoxazine of claim 12; and
b) about 95% to about 5% by volume of fibrous reinforcement.

18. A material comprising a polybenzoxazine of claim 12, wherein the material has a specific tensile modulus of about 14 GPa-cm³/g or higher.

19. A material comprising: a polybenzoxazine of claim 12, wherein the material has a specific tensile strength of about 73 MPa-cm³/g or higher.

20. A material comprising: a polybenzoxazine of claim 12, wherein the material has a specific flexural modulus of about 8 GPa-cm³/g or higher.
